(19) United States
(12) Patent Application Publication
(10) Pub. No.: US 2018/0092097 A1
(43) Pub. Date: Mar. 29, 2018

(54) RADIO RELAY DEVICE, COMMUNICATION DEVICE, AND RADIO RELAY METHOD

(71) Applicant: FUJITSU LIMITED, Kawasaki-shi (JP)

(72) Inventor: Hitoshi Yokoyama, Shinagawa (JP)

(73) Assignee: FUJITSU LIMITED, Kawasaki-shi, Kanagawa (JP)

(21) Appl. No.: 15/676,537

(22) Filed: Aug. 14, 2017

(30) Foreign Application Priority Data
Sep. 23, 2016 (JP) 2016-186112

(51) Int. Cl. H04W 72/04; H04B 7/155

(52) U.S. Cl. CPC H04W 72/0453; H04B 7/15542

(57) ABSTRACT

A radio relay device that performs wireless communication with a communication device and a base station device using at least one carrier, the radio relay device includes, an acquisition unit that acquires inter-communication-device information on the wireless communication between the radio relay device and the communication device, and a determination unit that determines the number of carriers between the radio relay device and the communication device on the basis of the inter-communication-device information.

### CROSS-REFERENCE TO RELATED APPLICATION

This application is based upon and claims the benefit of priority of the prior Japanese Patent Application No. 2016-186112, filed on Sep. 23, 2016, the entire contents of which are incorporated herein by reference.

### FIELD

The present invention relates to a radio relay device, a communication device, and a radio relay method.

### BACKGROUND

In recent years, many terminal devices such as smartphones and tablet terminals have a tethering-based radio relay function. Tethering is a function of relaying communication of a communication device such as a personal computer that does not have a communication function of public communication such as long-term evolution (LTE), for example. A terminal device, which performs tethering, establishes wireless fidelity (Wi-Fi) connection with a communication device and transmits and receives data transmitted and received by the communication device to a base station device of a public communication network, thereby realizing communication between the communication device and the base station device.

Wi-Fi has a plurality of communication modes and a frequency band of a radio resource to be used is determined for each communication mode.

Japanese Laid-open Patent Publication Nos. 2014-107783 and 2015-198446 disclose techniques related to tethering.

A radio relay device that performs wireless communication with a communication device and a base station device using at least one carrier, the radio relay device includes, an acquisition unit that acquires inter-communication-device information on the wireless communication between the radio relay device and the communication device, and a determination unit that determines the number of carriers between the radio relay device and the communication device on the basis of the inter-communication-device information.

### SUMMARY

An aspect of the present invention provides a radio relay device, a communication device, and a radio relay method capable of using radio resources efficiently.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a communication system 10.

FIG. 2 is a diagram illustrating an example of a sequence in which the communication device 100 in the communication system 10 establishes Wi-Fi connection with the radio relay device 300 and performs a tethering process.

FIG. 3 is a diagram illustrating a configuration example of the radio relay device 300.

FIG. 4 is a diagram illustrating a configuration example of the communication device 100.

FIG. 5 is a diagram illustrating a configuration example of the base station device 200.

FIG. 6 is a diagram illustrating an example of a sequence of a carrier count changing process in the communication system 10.

FIG. 7 is a diagram illustrating an example of a process flow of the communication information acquisition process S204.

FIG. 8 is a diagram illustrating an example of a process flow of the carrier determination process S205.

FIG. 9 is a diagram illustrating an example of a list of executable communication modes, the number of carriers, and the activation rate.

FIG. 10 is a diagram illustrating an example of a sequence of a carrier count changing process of the communication system 10.

FIG. 11 is a diagram illustrating an example of a process flow of the communication information acquisition process S204 in the second embodiment.

FIG. 12 is a diagram illustrating an example of a process flow of the communication information acquisition process S204 in the third embodiment.

FIG. 13 is a diagram illustrating an example of a process flow of the carrier determination process S205 in the third embodiment.

FIG. 14 is a diagram illustrating an example in which the number of carriers is increased.

FIG. 15 is a diagram illustrating an example of measured and estimated values of the communication speed for each number of carriers.

FIG. 16 is a diagram illustrating an example in which the number of carriers is decreased.

FIG. 17 is a diagram illustrating an example of measured and estimated values of the communication speed for each number of carriers.

FIG. 18 is a diagram illustrating an example of a process flow of the communication information acquisition process S204 of the fourth embodiment.

FIG. 19 is a diagram illustrating an example of a process flow of the carrier determination process S205 of the fourth embodiment.

FIG. 20 is a diagram illustrating an example of a process flow of the index determination process.

FIG. 21 is a diagram illustrating an example of the uplink and downlink communication speeds.

### DESCRIPTION OF EMBODIMENTS

There are cases in which radio resources are not used efficiently between a communication device and a terminal device (hereinafter referred to as a radio relay device) which performs tethering. For example, when a small amount of data is transmitted and received between a base station device and a radio relay device, if radio resources of a frequency band wider than needed are used, there is a case where the radio resource to be used between the radio relay device and the communication device is not used effectively.

### First Embodiment

<Configuration Example of Communication System>

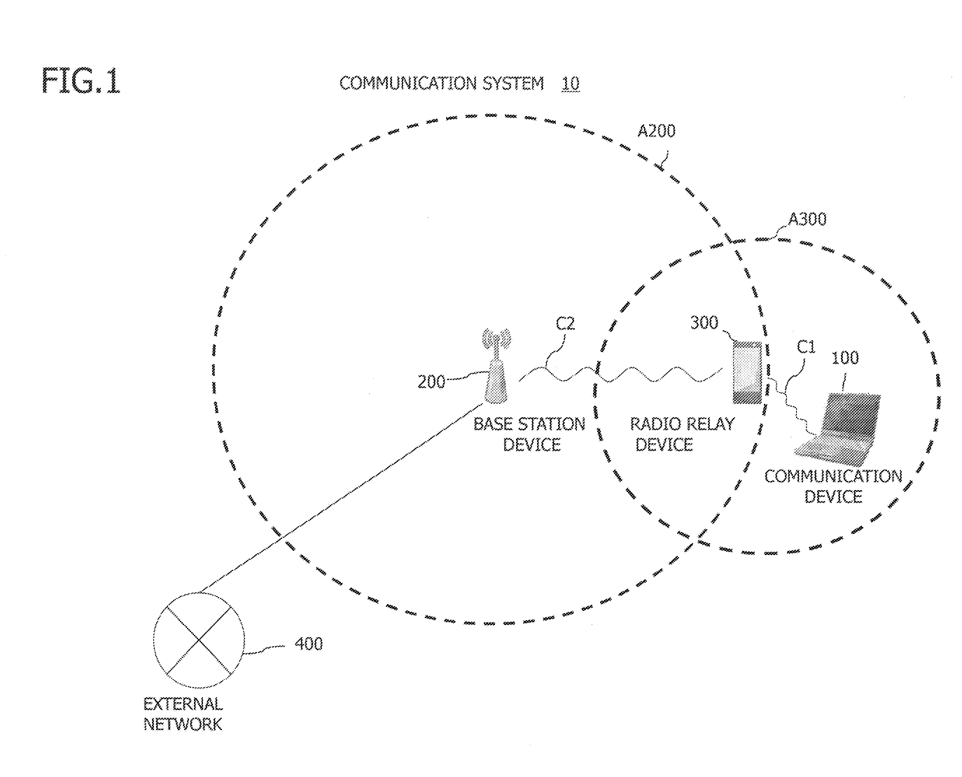

FIG. 1 is a diagram illustrating a configuration example of a communication system 10. The communication system 10 includes a communication device 100, a base station device 200, a radio relay device 300, and an external network 400. The communication device 100 is a personal computer or a tablet terminal that is unable to communicate with a public communication network, for example. The radio relay device 300 is a mobile communication device such as a tablet terminal or a smartphone that has a tethering function, for example.

The communication device 100 and the radio relay device 300 are connected wirelessly and the base station device 200 and the radio relay device 300 are connected wirelessly. The communication C2 between the base station device 200 and the radio relay device 300 is wireless communication compliant with standards such as LTE, for example. Moreover, the communication C1 between the radio relay device 300 and the communication device 100 is tethering-based Wi-Fi communication, for example.

The base station device 200 is connected to the external network 400 via a gateway or a base station controller, for example. An area A200 is a communication area in which wireless communication can be performed with the base station device 200 and an area A300 is a communication area in which wireless communication can be performed with the radio relay device 300.

In the communication system 10, the communication device 100 wirelessly connects to the radio relay device 300 without connecting directly to the base station device 200 when performing data communication with the external network 400, for example. The communication device 100 communicates with the base station device 200 via the radio relay device 300 and realizes data communication with the external network 400. In this way, the communication device 100 which is unable to connect directly to the base station device 200 since the communication device 100 is not located within the communication area A200 or does not has a function of connecting to the base station device 200 can perform wireless communication with the base station device 200 via the radio relay device 300.

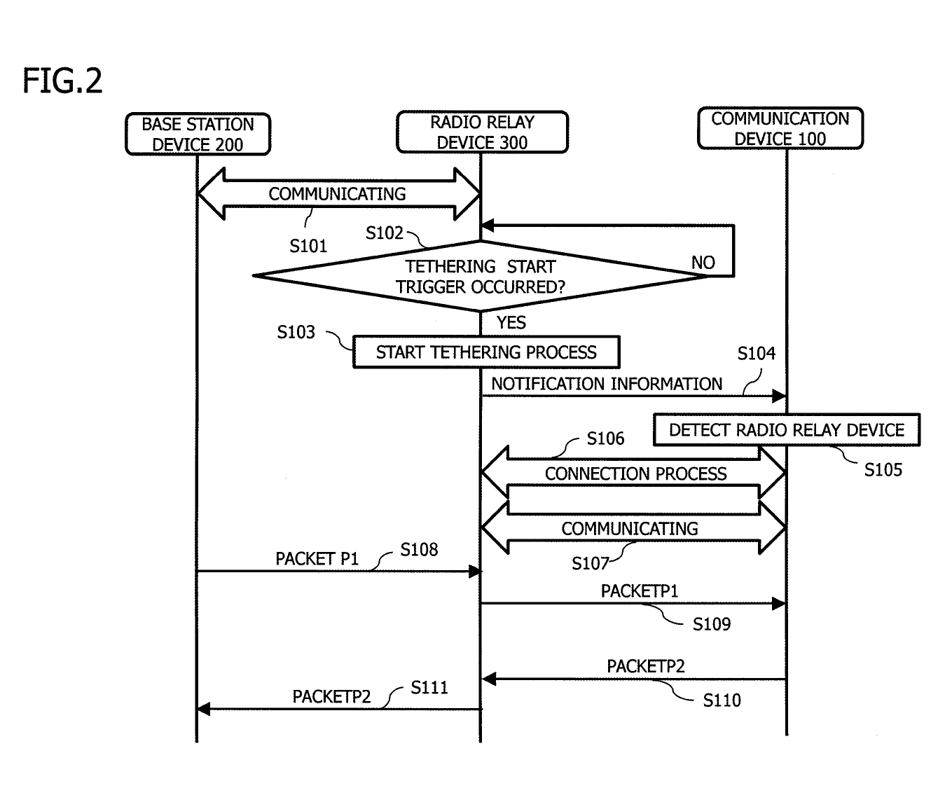

FIG. 2 is a diagram illustrating an example of a sequence in which the communication device 100 in the communication system 10 establishes Wi-Fi connection with the radio relay device 300 and performs a tethering process. The radio relay device 300 located within the communication area A200 of the base station device 200 is wirelessly communicating (S101) with the base station device 200. Radio resources used for communication between the base station device 200 and the radio relay device 300 are determined by the base station device 200. The base station device 200 may establish wireless connection with a communication device other than the communication device 100 located within the communication area A200 or a radio relay device other than the radio relay device 300. The base station device 200 determines radio resources to be used for communication with the radio relay device 300 on the basis of the radio resources allocated to devices other than the radio relay device 300 to which the base station device 200 is wirelessly connected and the degree of interference of radio waves around the base station device 200.

The radio relay device 300 monitors whether a tethering start trigger for starting a process of tethering the communication between the communication device 100 and the base station device 200 has occurred (S102). The tethering start trigger is activation of a tethering program operated when the radio relay device 300 is operated by the user of the radio relay device 300 or the system administrator of the communication system 10, for example. Moreover, a relay start trigger may occur when the radio relay device 300 is located at or moves to an end of the communication area A200. The radio relay device 300 measures the reception power of radio waves transmitted by the base station device 200, for example, and detects that the radio relay device 300 is located at the end of the communication area A200 when the measured reception power is equal to or less than a predetermined value.

Upon detecting the tethering start trigger (S102: Yes), the radio relay device 300 starts the tethering process (S103). In the tethering process, the radio relay device 300 operates as an access point for neighboring communication devices. The radio relay device 300 transmits notification information in a predetermined frequency band (S104). The notification information includes the identifier of the radio relay device 300, for example. Moreover, the notification information is a beacon in the Wi-Fi, for example, and is transmitted at fixed intervals.

The communication device 100 searches for a predetermined frequency and detects the radio relay device 300 as an access point (S105) upon receiving the notification information (S104). Moreover, the communication device 100 performs Wi-Fi connection with the radio relay device 300 (S106) to enter into a communicating state (S107).

Upon receiving a packet P1 transmitted to the communication device 100 from the base station device 200 as the tethering process (S108), the radio relay device 300 transmits the received packet P1 to the communication device 100 (S109). Moreover, upon receiving a packet P2 transmitted to the base station device 200 from the communication device 100 as the tethering process (S110), the communication device 100 transmits the received packet P2 to the base station device 200 (S111).

In this manner, the radio relay device 300 performs the tethering process to relay the communication between the communication device 100 and the base station device 200. Moreover, the radio relay device 300 changes a frequency bandwidth to be used for communication between the radio relay device 300 and the communication device 100 periodically, for example. The frequency bandwidth increases as the number of carriers increases and decreases as the number of carriers decreases, for example. A carrier is a radio resource having a predetermined frequency bandwidth per unit period and is a resource block, for example. The radio relay device 300 determines the number of carriers to be changed on the basis of inter-communication-device information on the communication between the radio relay device 300 and the communication device 100.

Next, how the radio relay device 300 determines the number of carriers according to a first embodiment will be described. In the first embodiment, the radio relay device 300 performs wireless communication with the communication device 100 and the base station device 200 using one or a plurality of carriers and relays wireless communication between the communication device 100 and the base station device 200. Moreover, the radio relay device 300 includes an acquisition unit that acquires inter-communication-device information on the communication between the radio relay device 300 and the communication device 100 and a determination unit that determines the number of carriers between the radio relay device 300 and the communication device 100 on the basis of the inter-communication-device information.

<Configuration Example of Radio Relay Device>

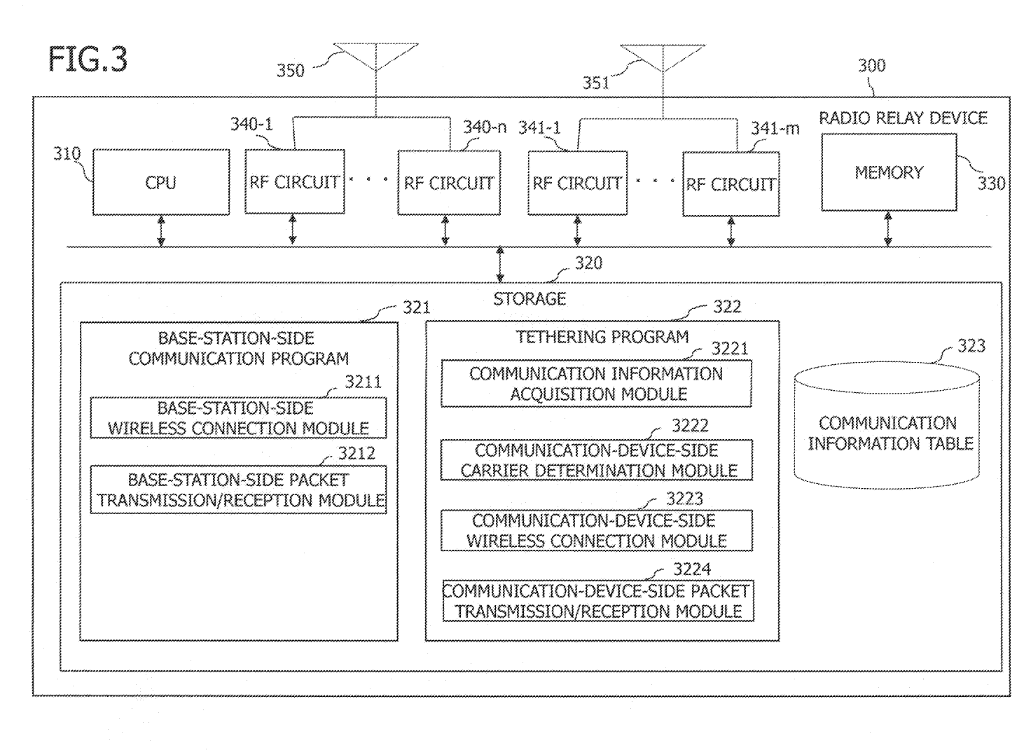

FIG. 3 is a diagram illustrating a configuration example of the radio relay device 300. The radio relay device 300 is a smartphone or a tablet terminal having a tethering function, for example. The radio relay device 300 includes a central processing unit (CPU) 310, a storage 320, a memory 330 such as a dynamic random access memory (DRAM), radio frequency (RF) circuits 340-1 to 340-n, RF circuits 341-1 to 341-m, an antenna 350, and an antenna 351.

The storage 320 is an auxiliary storage device such as a flash memory or a solid state drive (SSD) that stores a program or data. The storage 320 stores a base-station-side communication program 321, a tethering program 322, and a communication information table 323.

The communication information table 323 is a table that stores communication information. The communication information is inter-communication-device information, for example. The inter-communication-device information is the percentage (hereinafter referred to an activation rate) of a period in which data is transmitted and received between communication devices 100 per unit period, or the communication speed between the radio relay device and the communication device 100. Moreover, the communication information may include inter-base-station information on the communication between the radio relay device 300 and the base station device 200. The inter-base-station information is a communication speed between the radio relay device and the base station device 200, for example. The communication information table 323 is updated when the radio relay device 300 acquires the communication information.

The memory 330 is an area on which the program stored in the storage 320 is loaded. Moreover, the memory 330 is also used as an area in which a program stores data.

The RF circuits 340-1 to 340-n and the RF circuits 341-1 to 341-m are devices that realize transmission and reception of radio waves. The RF circuits 340-1 to 340-n perform transmission and reception of radio waves to and from the communication device 100, for example, via the antenna 350. The RF circuits 341-1 to 341-m perform transmission and reception of radio waves to and from the base station device 200, for example, via the antenna 351.

The RF circuit 340 in the radio relay device 300 can transmit and receive one carrier with respect to one RF circuit, for example. The radio relay device 300 energizes the number of RF circuits corresponding to the number of carriers to be used for communication with the communication device 100. Since the greater the number of carriers to be used for communication in the radio relay device 300, the greater the number of RF circuits to be energized, the greater the number of carriers, the greater the power consumption.

The CPU 310 is a processor that loads the program stored in the storage 320 on the memory 330, executes the loaded program, and realizes respective processes.

The CPU 310 performs a base-station-side communication process by executing the base-station-side communication program 321. The base-station-side communication process is a process in which the radio relay device 300 performs wireless communication with the base station device 200. The base-station-side communication process is a process of searching for a wirelessly connectable base station device 200, establishing wireless connection with the detected base station device 200, and transmitting and receiving packets. The CPU 310 performs a process of searching for a wirelessly connectable base station device 200 and establishing wireless connection with the detected base station device 200 by executing a base-station-side wireless connection module 3211. Moreover, the CPU 310 performs a process of transmitting and receiving packets to and from the wirelessly connected base station device 200 by executing a base-station-side packet transmission/reception module 3212.

The CPU 310 performs the tethering process by executing the tethering program 322. The tethering process is a process in which the radio relay device 300 establishes Wi-Fi-based wireless connection with the communication device 100 and relays packets transmitted and received between the base station device 200 and the communication device 100. Moreover, the tethering process is a process of acquiring communication information upon detecting a trigger for changing the number of carriers to be used for communication with the communication device 100, determining the number of carriers to be changed, and controlling the communication device 100 so as to perform communication using the determined number of carriers.

The CPU 310 constructs an acquisition unit by executing a communication information acquisition module 3221 and performs a communication information acquisition process as the acquisition unit. The communication information acquisition process is a process of acquiring communication information. The communication information acquisition process is a process of measuring the activation rate between the radio relay device and the communication device 100, for example. The activation rate is measured by measuring a period in which radio data is transmitted and received in an RF circuit, for example. Moreover, the communication information acquisition process is a process of requesting the communication device 100 to transmit communication information (activation rate) and receiving the communication information (activation rate) transmitted from the communication device 100.

The CPU 310 constructs a determination unit by executing a communication-device-side carrier determination module 3222 and performs a communication-device-side carrier determination process as the determination unit. The communication-device-side carrier determination process is a process of determining the frequency band of a carrier to be used for communication between the radio relay device 300 and the communication device 100 and the number of carriers to be used. In the communication-device-side carrier determination process, the CPU 310 determines the frequency band of the carrier to be used and the number of carriers when establishing wireless connection with the communication device 100 and determines the number of carriers to be changed when a carrier count changing trigger occurs.

The CPU 310 constructs a control unit by executing a communication-device-side wireless connection module 3223 and performs a communication-device-side wireless connection process as the control unit. The communication-device-side wireless connection process is a function of allowing the radio relay device to establish wireless connection with the communication device 100 using the determined frequency band and the determined number of carriers. In the communication-device-side wireless connection process, the CPU 310 transmits a message to the communication device 100 so that a Wi-Fi communication mode is changed to a Wi-Fi communication mode corresponding to the determined frequency band and the determined number of carriers, for example.

The CPU 310 performs a communication-device-side packet transmission/reception process by executing a communication-device-side packet transmission/reception module 3224. The communication-device-side packet transmission/reception process is a process of transmitting and receiving packets between the communication device 100 and the radio relay device 300. The radio relay device 300 relays packets transmitted and received between the base station device 200 and the communication device 100 by performing the communication-device-side packet transmission/reception process in synchronization with the base-station-side packet transmission/reception process.

<Configuration Example of Communication Device>

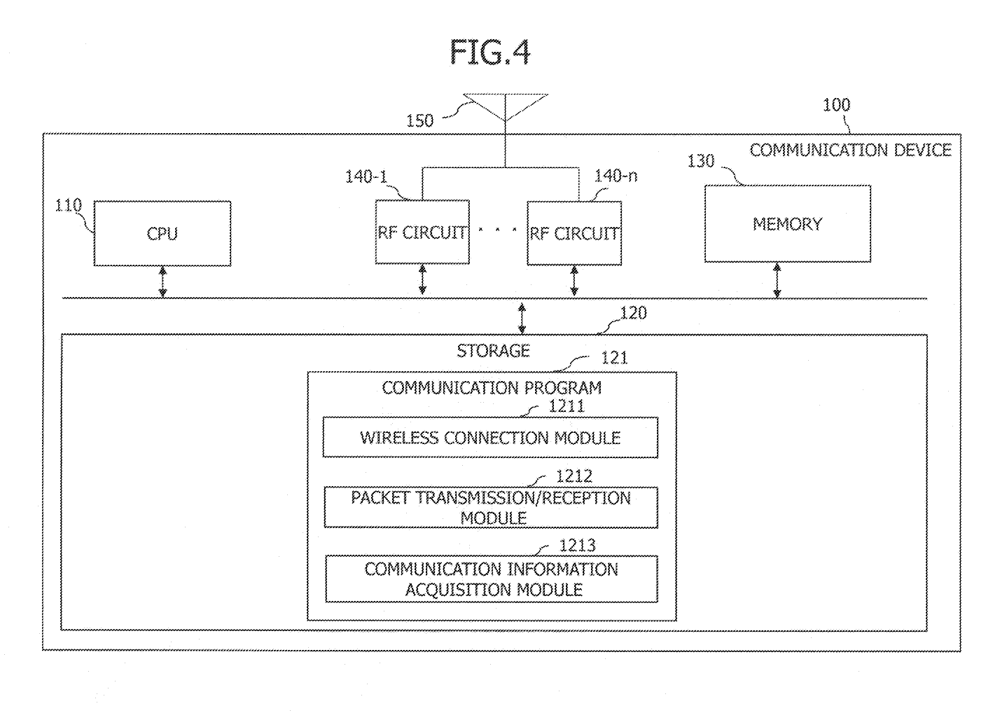

FIG. 4 is a diagram illustrating a configuration example of the communication device 100. The communication device 100 is a personal computer, for example, and includes a CPU 110, a storage 120, a memory 130 such as a DRAM, RF circuits 140-1 to 140-x, and an antenna 150.

The CPU 110, the storage 120, the memory 130, the RF circuits 140-1 to 140-x, and the antenna 150 are the same devices as the CPU 310, the storage 320, the memory 330, the RF circuits 340-1 to 340-n, and the antenna 350 illustrated in FIG. 3, respectively.

The storage 120 stores a communication program 121.

The CPU 110 constructs a receiving unit and a radio control unit by executing the communication program 121 and performs a communication process as the receiving unit or the radio control unit. The communication process is a process of communicating with the radio relay device 300 or the base station device 200.

The CPU 110 constructs a receiving unit and a changing unit by executing a wireless connection module 1211, receives a communication mode change instruction as the receiving unit, and changes the communication mode as the changing unit. Furthermore, the CPU 110 performs a wireless connection process with the radio relay device 300 by executing the wireless connection module 1211.

The CPU 110 performs a packet transmission/reception process by executing a packet transmission/reception module 1212. The packet transmission/reception process is a process of transmitting and receiving packets to and from the radio relay device 300.

The CPU 110 constructs a transmission unit and a measurement unit by executing a communication information acquisition module 1213, measures the communication information as the measurement unit, and transmits the measured communication information to the radio relay device 300 as the transmission unit.

<Configuration Example of Base Station Device>

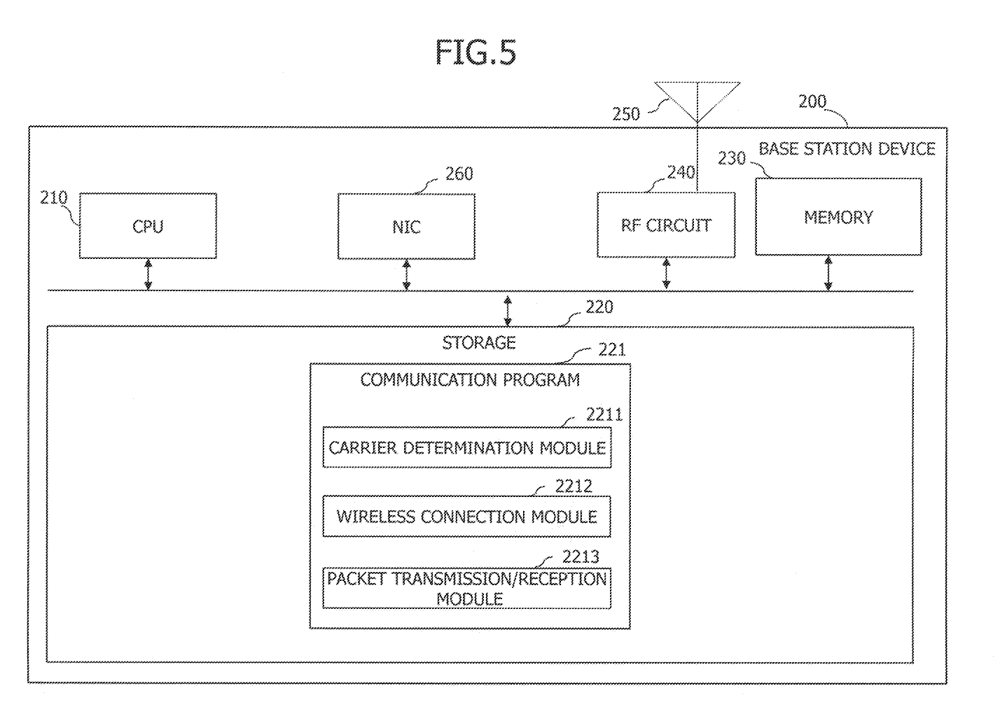

FIG. 5 is a diagram illustrating a configuration example of the base station device 200. The base station device 200 includes a CPU 210, a storage 220, a memory 230, an RF circuit 240, an antenna 250, and a network interface card (NIC) 260.

The CPU 210, the storage 220, the memory 230, the RF circuit 240, and the antenna 250 are the same devices as the CPU 310, the storage 320, the memory 330, the RF circuits 340-1 to 340-n, and the antenna 350 illustrated in FIG. 3, respectively.

The storage 220 stores a communication program 221.

The NIC 260 is a device that connects to and communicates with the external network 400. The NIC 260 is connected to a gateway device that relays communication between different networks, a base station control unit that controls a plurality of base station devices, and a switch, a hub, or the like by a cable such as an optical cable, for example.

The CPU 210 performs a communication process by executing a communication program 221. The communication process is a process of communicating with the radio relay device 300 or the communication device 100.

The CPU 210 performs a carrier determination process by executing a carrier determination module 2211. The carrier determination process is a process of determining the frequency band of a carrier to be used for wireless communication with a plurality of communication devices or radio relay devices in the communication area A200 and the number of carriers. The base station device 200 searches for carriers having a low degree of interference among carriers other than the carrier allocated to devices other than the radio relay device 300 and determines a carrier on the basis of the wireless communication capability of the radio relay device 300.

The CPU 210 performs a wireless connection process by executing a wireless connection module 2212. The wireless connection process is a process of establishing wireless connection with the communication device or the radio relay device 300 in the communication area A200 and is the same as the communication-device-side wireless connection process of the radio relay device 300.

The CPU 210 performs a packet transmission/reception process by executing a packet transmission/reception module 2213. The packet transmission/reception process is a process of transmitting and receiving packets to and from the communication device or the radio relay device 300 in the communication area A200 and is the same as the communication-device-side packet transmission/reception process of the radio relay device 300.

<Carrier Number Changing Process>

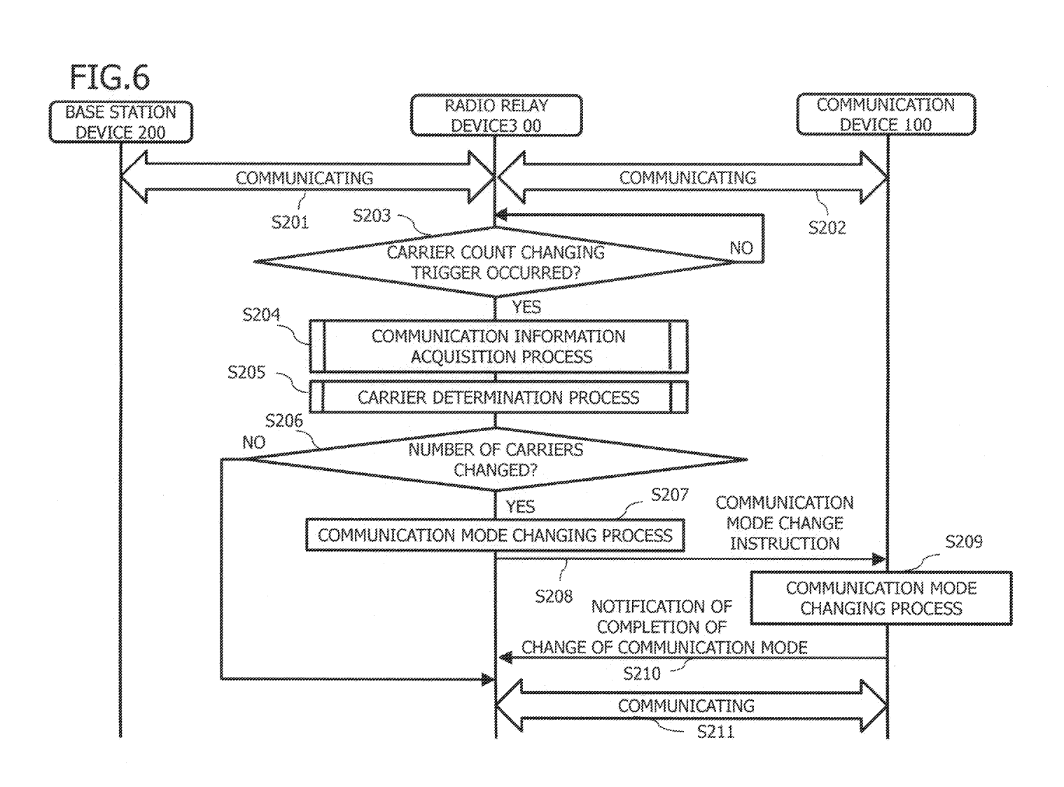

FIG. 6 is a diagram illustrating an example of a sequence of a carrier count changing process in the communication system 10. The base station device 200 is communicating with the radio relay device 300 and the radio relay device 300 is communicating with the communication device 100 (S201 and S202). In the first embodiment, the radio relay device 300 acquires inter-communication-device information as communication information. The inter-communication-device information in the first embodiment is the activation rate between the radio relay device 300 and the communication device 100. A low activation rate means that a period in which communication is not performed between the radio relay device 300 and the communication device 100 is long and means that a period in which radio resources are unnecessarily occupied by the radio relay device 300 and the communication device 100 is long. That is, a low activation rate means that resources are used unnecessarily and a high activation rate means that radio resources are used more efficiently.

The radio relay device 300 monitors a carrier count changing trigger until the carrier count changing trigger occurs (S203: No). The carrier count changing trigger occurs periodically (for example, at intervals of one minute). The radio relay device 300 issues an interval timer and detects a timeout of the interval timer as the carrier count changing trigger, for example.

Upon detecting the occurrence of the carrier count changing trigger (S203: Yes), the radio relay device 300 performs a communication information acquisition process (S204).

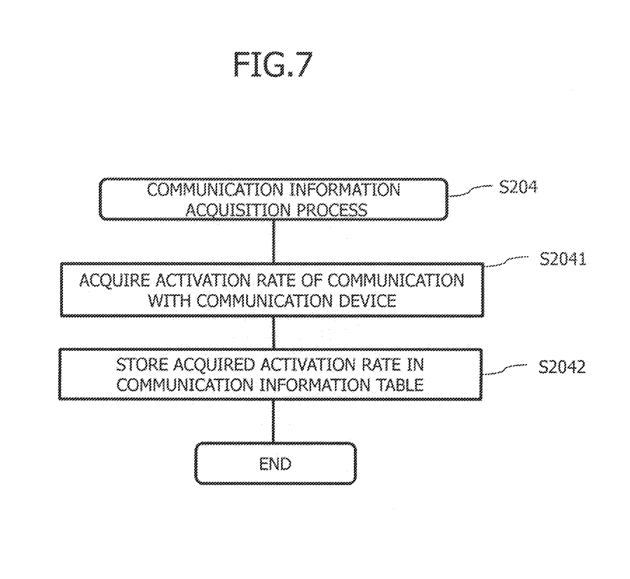

FIG. 7 is a diagram illustrating an example of a process flow of the communication information acquisition process S204. The radio relay device 300 acquires the activation rate of the communication between communication devices 100 (S2041). The radio relay device 300 acquires the activation rate between the radio relay device 300 and the communication device 100 by measuring a period in which data is transmitted and received to and from the communication device 100 in a unit period, for example.

The radio relay device 300 stores the acquired activation rate between the radio relay device 300 and the communication device 100 in the communication information table 323 as the communication information (S2042).

Returning to FIG. 6, the radio relay device 300 performs a carrier determination process (S205).

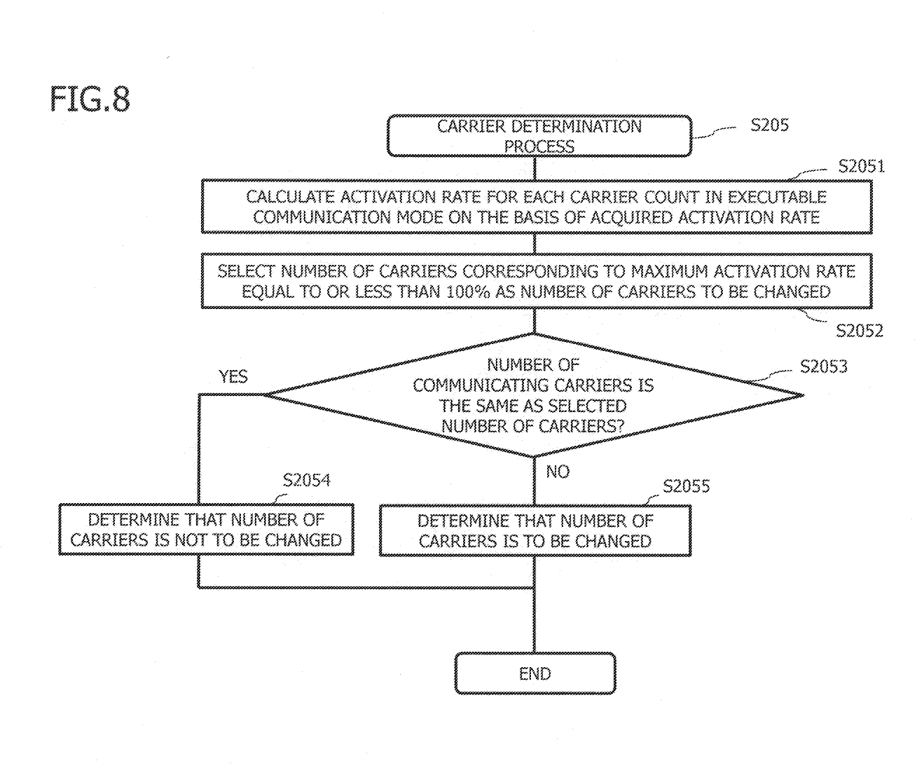

FIG. 8 is a diagram illustrating an example of a process flow of the carrier determination process S205. The radio relay device 300 calculates the activation rate for each carrier count in an executable communication mode on the basis of the acquired activation rate and the number of carriers when the activation rate is acquired (S2051). The executable communication mode is a Wi-Fi communication mode compatible with both the radio relay device 300 and the communication device 100, for example. The Wi-Fi communication mode corresponds to a communication standard formulated by the Institute of Electrical and Electronics Engineers (IEEE), for example. “IEEE” is added to the word of the Wi-Fi communication mode (communication standard) (for example, IEEE802.11b). In the Wi-Fi standards, the frequency band of a radio resource to be used, the channel width, and the like are defined for each communication mode. Hereinafter, the communication mode will be described by omitting IEEE.

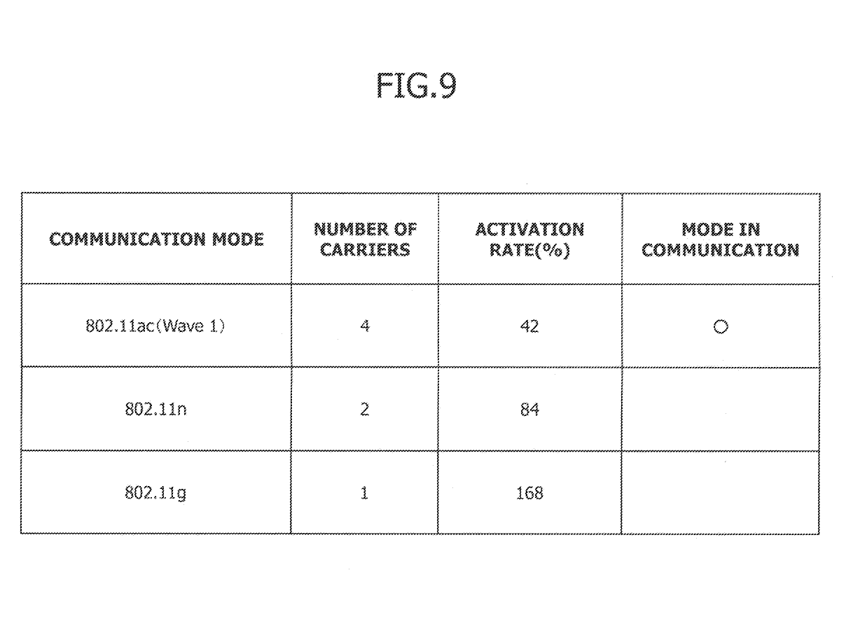

FIG. 9 is a diagram illustrating an example of a list of executable communication modes, the number of carriers, and the activation rate. For example, a communication mode compatible with the communication device 100 includes “802.11ac Wave1,” “802.11n,” “802.11g,” and “802.11a”. Moreover, the executable communication mode of the radio relay device 300 includes “802.11ac Wave1,” “802.11n,” “802.11g,” and “802.11b,” for example. In this case, the three communication modes “802.11ac Wave1,” “802.11n,” and “802.11g” which are communication modes which are commonly compatible with both the communication device 100 and the radio relay device 300 are executable communication modes as illustrated in FIG. 9.

Returning to FIG. 8, the radio relay device 300 calculates activation rates of carrier counts 2 and 1 which are the number of carriers corresponding to an executable communication mode other than the communication mode (a communication mode being presently used) in which an activation rate is acquired. The radio relay device 300 calculates an estimated activation rate on the basis of a general rule that the activation rate is inverse-proportional to the number of carriers.

Referring to FIG. 9, the radio relay device 300 is communicating in the communication mode “802.11ac Wave1”. The radio relay device 300 calculates the activation rates for the communication modes “802.11g” and “802.11n” on the basis of the acquired activation rate 42% and the number of carriers (the number of communicating carriers) 4 when the activation rate is acquired. As illustrated in FIG. 9, the radio relay device 300 calculates the activation rate 84% for the number of carriers 2 and the activation rate 168% for the number of carriers 1.

The radio relay device 300 selects the number of carriers corresponding to the maximum activation rate which is equal to or less than 100% from the acquired activation rates and the calculated activation rates as the number of carriers to be changed (S2052). Since the activation rate obtained in actual operation does not exceed 100%, the fact that the calculated activation rate exceeds 100% means that the radio resource (the number of carriers) is deficient for the data transmitted and received. Therefore, a condition that the activation rate is equal to or less than 100% is set to prevent deficiency of radio resources to be used for communication between communication devices 100.

As the activation rate approaches 100%, the amount of unnecessary radio resources which are not used for data communication is small. Therefore, a condition that the maximum activation rate is selected is set to prevent the use of unnecessary radio resources.

In FIG. 9, the radio relay device 300 selects the number of carriers 2 corresponding to the activation rate 84% that satisfies the condition that the activation rate is the maximum among the activation rates 42% and 84% that satisfy the condition that the activation rate is equal to or less than 100% as the number of carriers to be changed (S2052).

The radio relay device 300 determines whether the number of communicating carriers is the same as the selected number of carriers (S2053). When the number of communicating carriers is the same as the selected number of carriers (S2053: Yes), the radio relay device 300 determines that the number of carriers is not to be changed (S2054). On the other hand, when the number of communicating carriers is different from the selected number of carriers (S2053: No), the radio relay device 300 determines that the number of carriers is to be changed (S2055). In the case of FIG. 9, the radio relay device 300 determines that the number of carriers is to be changed.

Returning to FIG. 6, the radio relay device 300 determines whether there is a change in the number of carriers (S206). When there is no change in the number of carriers (S206: No), the radio relay device 300 ends the process and enters into a communicating state (S211).

On the other hand, when there is a change in the number of carriers (S206: Yes), the radio relay device 300 performs a communication mode changing process (S207). The communication mode changing process S207 is a process of changing the communication mode between the radio relay device 300 and the communication device 100 to a communication mode corresponding to the number of carriers to be changed. Since 2 is determined as the number of carriers to be changed in FIG. 9, the radio relay device 300 changes the communication mode to the communication mode “802.11n” corresponding to the number of carriers 2.

The radio relay device 300 transmits a communication mode change instruction to the communication device 100 (S208). The communication mode change instruction is a message including information on the communication mode to be changed.

Upon receiving the communication mode change instruction (S208), the communication device 100 performs a communication mode changing process (S209). When the change of the communication mode as instructed from the radio relay device 300 is completed in the communication mode changing process S209, the communication device 100 transmits a communication mode change completion notification to the radio relay device 300 (S210). The radio relay device 300 and the communication device 100 enter into a communicating state in the changed communication mode (S211).

In the first embodiment, the radio relay device 300 changes the number of carriers on the basis of the activation rate between the radio relay device 300 and the communication device 100. In this way, the radio relay device 300 can control the activation rate between the radio relay device 300 and the communication device 100 to approach 100% and can use the radio resources efficiently without measuring the activation rate between the radio relay device 300 and the base station device 200. Since the activation rate can be acquired by simply measuring the energization period of the RF circuit, for example, it is possible to suppress a processing load of the radio relay device 300 and a programming amount.

### Second Embodiment

Next, a second embodiment will be described. In the second embodiment, the communication information (activation rate) is acquired from the communication device 100.

<Communication Information Acquisition Process>

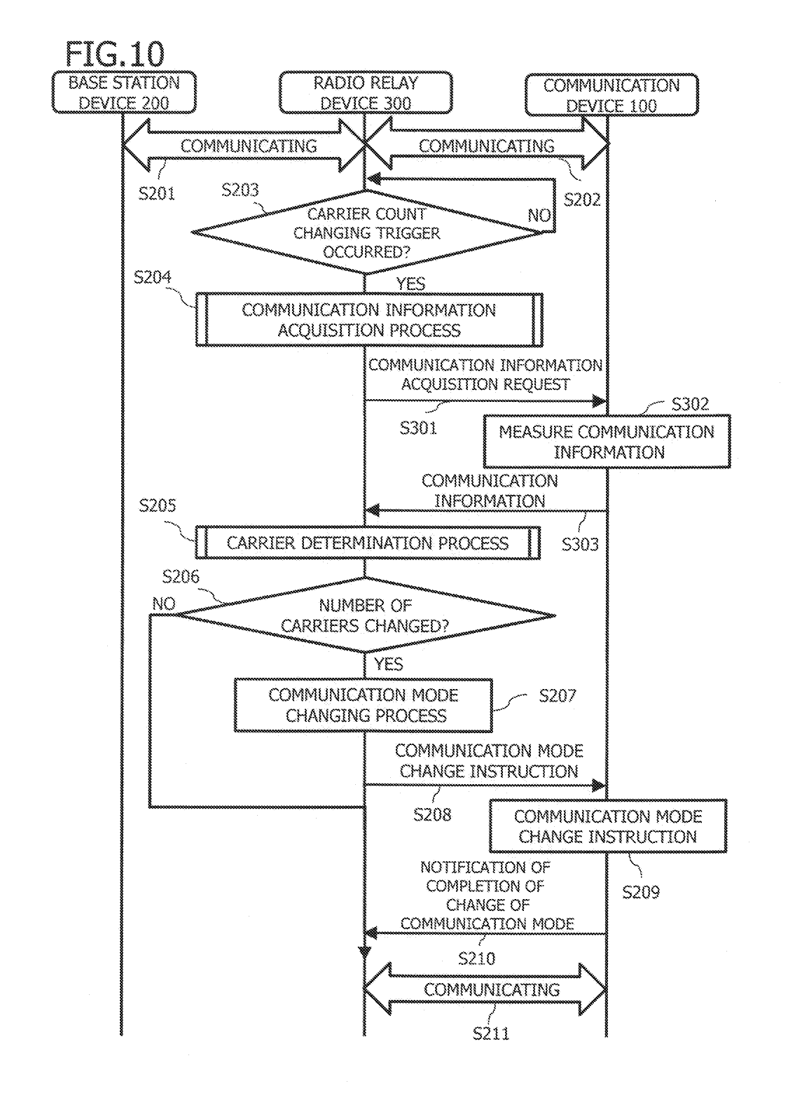

FIG. 10 is a diagram illustrating an example of a sequence of a carrier count changing process of the communication system 10. The processes up to the process S203 of monitoring the occurrence of a carrier count changing trigger and the processes subsequent to the carrier determination process S205 are the same as those of the sequence illustrated in FIG. 6. Hereinafter, the communication information acquisition process S204 will be described.

Upon detecting the occurrence of the carrier count changing trigger (S203: Yes), the radio relay device 300 performs a communication information acquisition process (S204).

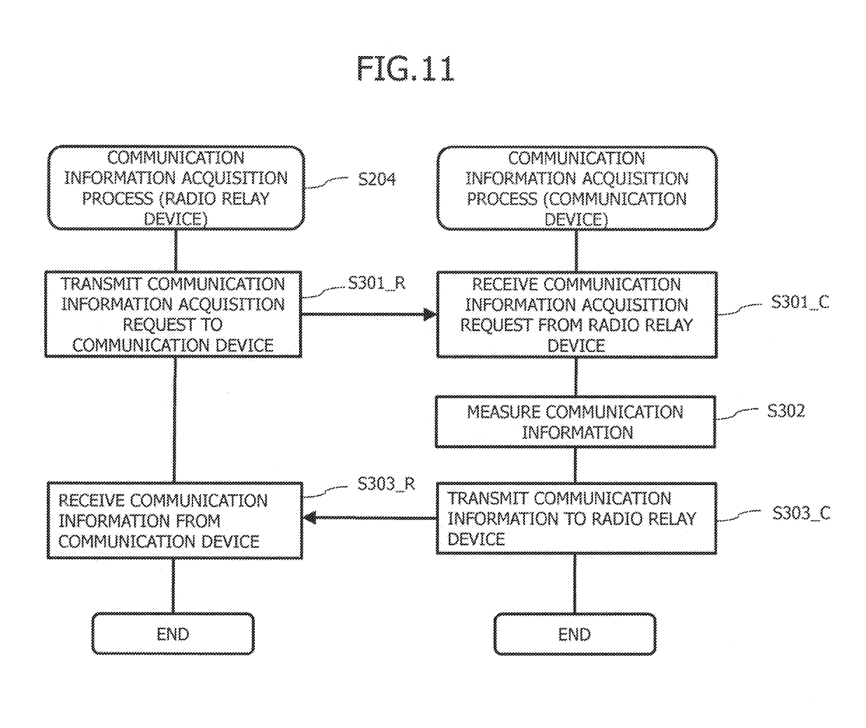

FIG. 11 is a diagram illustrating an example of a process flow of the communication information acquisition process S204 in the second embodiment. FIG. 11 illustrates an example of the processes of the radio relay device 300 and the communication device 100.

The radio relay device 300 transmits a communication information acquisition request to the communication device 100 (S301_R). The communication device 100 receives the communication information acquisition request (S302_C) and measures the communication information (S302).

The communication device 100 measures the communication information (activation rate) by measuring a period in which data is transmitted and received to and from the radio relay device 300 in a unit period. The communication device 100 may measure the communication information in advance rather than measuring the communication information in response to reception of the communication information acquisition request.

The communication device 100 transmits the measured communication information to the radio relay device 300 (S303_C). The radio relay device 300 receives the communication information (S303_R) and ends the communication information acquisition process.

Returning to FIG. 10, in the communication information acquisition process S204, the radio relay device 300 transmits a communication information acquisition request (S301). The communication device 100 receives the communication information acquisition request and measures the communication information (S302). The communication device 100 transmits the communication information to the radio relay device 300 (S303).

In the second embodiment, the radio relay device 300 receives the communication information from the communication device 100. When the radio relay device 300 is connected to a plurality of communication devices, for example, and the communication information is the activation rate between the radio relay device 300 and the communication device 100, the radio relay device 300 is unable to determine whether the communication information is information on the communication with other communication devices or the communication with the communication device 100 even when the energization period of the RF circuit is measured. Due to this, the radio relay device 300 has to perform a process with a large processing load such as checking a destination of the packet by referring to the content of a packet. However, in the second embodiment, it is possible to suppress an increase in the processing load of the radio relay device 300 by causing the communication device 100 to measure the activation rate.

### Third Embodiment

Next, a third embodiment will be described. In the third embodiment, the acquisition unit further acquires inter-base-station information on the wireless communication between the base station device 200 and the radio relay device 300 and the determination unit determines the number of carriers between the radio relay device 300 and the communication device 100 on the basis of the inter-communication-device information and the inter-base-station information. Moreover, the inter-base-station information is information including a communication speed between the radio relay device 300 and the base station device 200. Furthermore, the inter-communication-device information is the communication speed between the radio relay device 300 and the communication device 100.

<Carrier Count Changing Process>

The sequence of the carrier count changing process is the same as that of FIG. 6. The communication information, the communication information acquisition process S204, and the carrier determination process S205 in the third embodiment are different from those of the first embodiment. Hereinafter, the processes until the carrier determination process S205 ends after the carrier count change trigger occurs (S203: Yes) in the sequence of FIG. 6 will be described.

The information that the radio relay device 300 acquires as the communication information includes the inter-base-station information which is the communication speed between the radio relay device 300 and the base station device 200 and the inter-communication-device information which is the communication speed between the radio relay device 300 and the communication device 100.

Upon detecting the occurrence of the carrier count change trigger (S203: Yes), the radio relay device 300 performs a communication information acquisition process (S204).

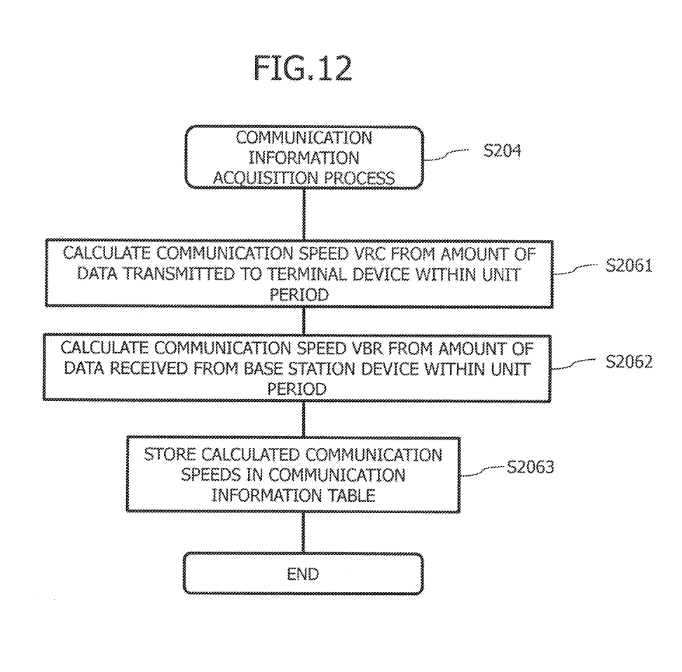

FIG. 12 is a diagram illustrating an example of a process flow of the communication information acquisition process S204 in the third embodiment. The radio relay device 300 calculates the communication speed with the communication device 100 from the amount of data transmitted to the communication device 100 within a unit period (S2061). The calculated communication speed (inter-communication-device information) with the communication device 100 is the communication speed of a downlink (the direction from the base station device 200 to the communication device 100) and will be referred to as a communication speed VRC (Velocity Relay station to Communication equipment). Moreover, the amount of data transmitted to the communication device 100 within a unit period is stored in an internal memory by the radio relay device 300, for example.

The radio relay device 300 calculates the communication speed with the base station device from the amount of data received from the base station device 200 within a unit period (S2062). The calculated communication speed (inter-base-station information) with the base station device 200 is the communication speed of a downlink and will be referred to as a communication speed VBR (Velocity Base station to Relay station). Moreover, the amount of data received from the base station device 200 within a unit period is stored in an internal memory by the radio relay device 300, for example, similarly to the amount of data transmitted to the communication device 100.

The radio relay device 300 stores the calculated communication speed VRC and VBR in the communication information table 323 (S2063).

The communication information acquired in the communication information acquisition process S204 in FIG. 12 is the downlink communication speed between the base station device 200 and the radio relay device 300 and the downlink communication speed between the radio relay device 300 and the communication device 100. The communication information acquired in the communication information acquisition process S204 is used as an index in the subsequent carrier determination process S205. The index in the carrier determination process may be the communication speed in the uplink (the direction from the communication device 100 to the base station device 200). When the uplink communication speed is used as the index in the carrier determination process, the communication information (the inter-base-station information and the inter-communication-device information) acquired in the communication information acquisition process is the uplink communication speed.

Returning to FIG. 6, the radio relay device 300 performs the carrier determination process (S205).

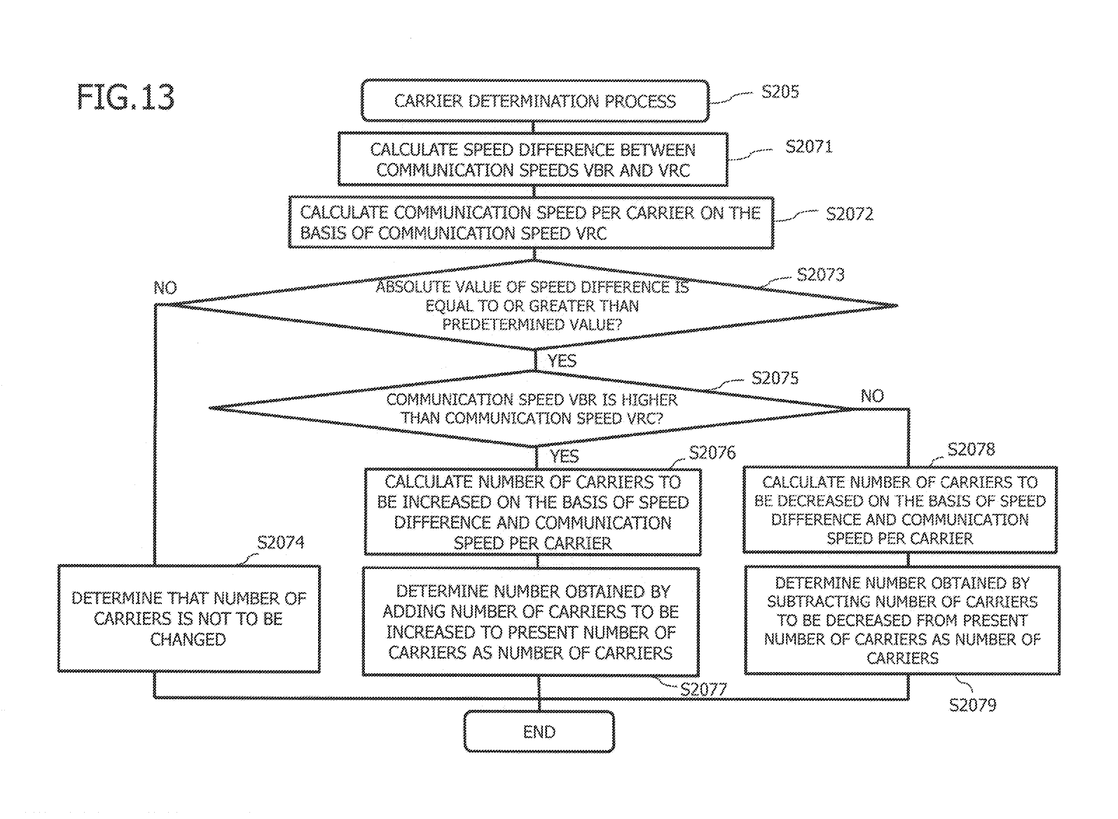

FIG. 13 is a diagram illustrating an example of a process flow of the carrier determination process S205 in the third embodiment. The radio relay device 300 calculates a speed difference between the communication speed VBR and the communication speed VRC from the acquired communication information (S2071). The speed difference is calculated by subtracting the communication speed VRC from the communication speed VBR, for example.

The radio relay device 300 calculates the communication speed per carrier on the basis of the communication speed VRC (S2072). The radio relay device 300 regards a value obtained by dividing the measured communication speed VRC by the number of carriers used for the communication between the radio relay device 300 and the communication device 100 as the communication speed per carrier.

The radio relay device 300 determines whether the absolute value of the speed difference is equal to or greater than a predetermined value (S2073). When the absolute value of the speed difference is less than the predetermined value (S2073: No), the radio relay device 300 determines that the difference between the communication speed VBR and the communication speed VRC is so small that it is not needed to change the number of carriers and determines that the number of carriers is not to be changed (S2074). The predetermined value is the communication speed per carrier, calculated in the calculation process S2072, for example. Moreover, the predetermined value may be a theoretical value of the communication speed per carrier, stored in advance in a memory, for example.

When the absolute value of the speed difference is equal to or greater than the predetermined value (S2073: Yes), the radio relay device 300 performs a process of changing the number of carriers between the radio relay device 300 and the communication device 100.

Subsequently, the radio relay device 300 determines whether the communication speed VBR is higher than the communication speed VRC (S2055). Hereinafter, a case in which the communication speed VBR is higher than the communication speed VRC (communication speed VBR>communication speed VRC) and a case in which the communication speed VBR is equal to or lower than the communication speed VRC (communication speed VBR≦communication speed VRC) will be described.

<1. Case in which Communication Speed VBR is Higher than Communication Speed VRC (Communication Speed VBR>Communication Speed VRC)>

When the communication speed VBR is higher (S2075: Yes), the radio relay device 300 calculates the number of carriers to be increased on the basis of the communication speed difference and the communication speed per carrier (S2076). The radio relay device 300 controls the communication speed VBR and the communication speed VRC to be equal by increasing the number of carriers between the radio relay device 300 and the communication device 100. That is, a quotient obtained by dividing the communication speed difference between the communication speed VBR and the communication speed VRC by the communication speed per carrier is the number of carriers to be increased. However, in many cases, since the communication speed difference is not an integer multiple of the communication speed per carrier, the quotient of the division is a value that contains a decimal point. Therefore, with regard to handling of the decimal point of the quotient, the radio relay device 300 determines the number of carriers to be increased depending on a condition (a first condition) that the communication speed VBR is lower than the communication speed VRC or a condition (a second condition) that the communication speed VBR is higher than the communication speed VRC.

<1.1 Case where First Condition is Satisfied>

The reason why the first condition (communication speed VBR<communication speed VRC) is provided is to prevent downlink data received from the radio relay device 300 to the communication device 100 from being delayed and prevent downlink data from being discarded due to occurrence of a buffer overflow by accelerating the communication speed VRC, for example.

In this case, the radio relay device 300 determines a minimum number of carriers to be increased, satisfying the first condition as the number of carriers to be increased (S2076). That is, the radio relay device 300 uses, as the number of carriers to be increased, a value obtained by rounding-up the decimal point of the quotient obtained by dividing the communication speed difference by the communication speed per carrier.

<1.2 Case where Second Condition is Satisfied>

The reason why the second condition (communication speed VBR>communication speed VRC) is provided is to prevent radio resources from being used unnecessarily rather than preventing the discard of data due to deficiency of radio resources, for example.

In this case, the radio relay device 300 determines a maximum number of carriers to be increased, satisfying the second condition as the number of carriers to be increased (S2076). That is, the radio relay device 300 uses, as the number of carriers to be increased, a value obtained by rounding-down the decimal point of the quotient obtained by dividing the communication speed difference by the communication speed per carrier. When the second condition is satisfied, since the decimal point is rounded down, and the number of carriers to be increased is smaller by one than the case where the first condition is satisfied, it is possible to reduce the number of radio resources to be used.

<2. Case where Communication Speed VBR is Equal to or Lower than Communication Speed VRC (Communication Speed VBR Communication Speed VRC)>

When the communication speed VBR is lower than the communication speed VRC (S2075: No), the radio relay device 300 calculates the number of carriers to be decreased on the basis of the communication speed difference and the communication speed per carrier (S2078). The radio relay device 300 controls the communication speed VBR and the communication speed VRC to be equal by decreasing the number of carriers between the radio relay device 300 and the communication device 100.

When the communication speed difference is not an integer multiple of the communication speed per carrier, the number of carriers to be decreased is determined so as to satisfy the first or second condition similarly to the case where the communication speed VBR is higher than the communication speed VRC.

<2.1 Case where First Condition is Satisfied>

In this case, the radio relay device 300 determines a maximum number of carriers to be decreased, satisfying the first condition as the number of carriers to be decreased (S2078). That is, the radio relay device 300 determines a value obtained by rounding-down the decimal point of the quotient obtained by dividing the communication speed difference by the communication speed per carrier as the number of carriers to be decreased.

<2.2 Case where Second Condition is Satisfied>

In this case, the radio relay device 300 determines a minimum number of carriers to be decreased, satisfying the second condition as the number of carriers to be decreased (S2078). That is, the radio relay device 300 determines a value obtained by rounding-up the decimal point of the quotient obtained by dividing the communication speed difference by the communication speed per carrier as the number of carriers to be decreased. When the second condition is satisfied, since the decimal point is rounded up, and the number of carriers to be decreased is greater by one than the case where the first condition is satisfied, it is possible to reduce the number of radio resources to be used.

As described above, the radio relay device 300 determines the number of carriers to be increased or decreased (S2076, S2078) and determines the number obtained by adding the number (S2077) of carriers to be increased to the present number of carriers or the number obtained by subtracting the number (S2079) of carriers to be decreased from the present number of carriers as the number of carriers.

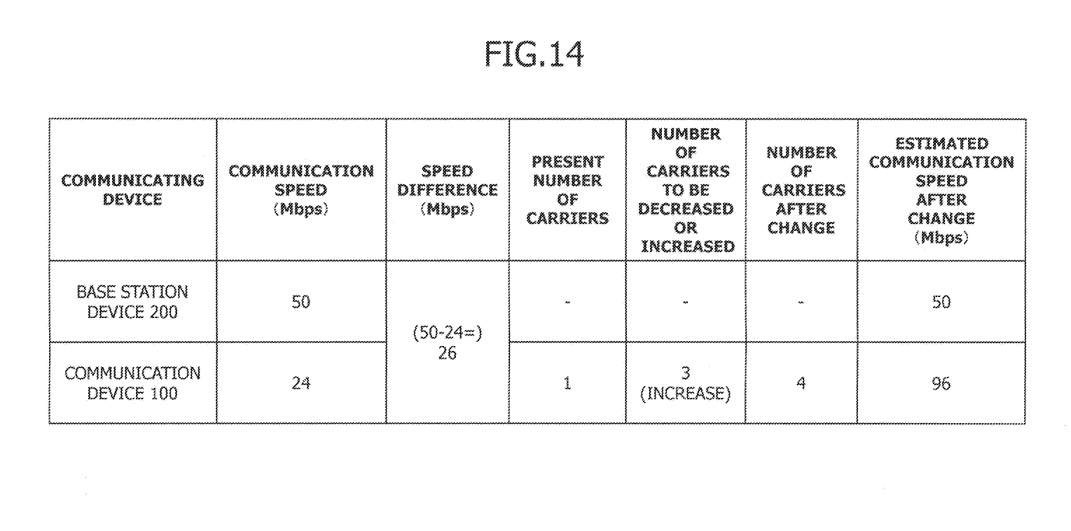

FIG. 14 is a diagram illustrating an example in which the number of carriers is increased. In the example of FIG. 14, the communication speed (communication speed VBR) with the base station device 200 is 50 megabit per second (Mbps) and the communication speed (communication speed VRC) with the communication device 100 is 24 Mbps. Hereinafter, the example of FIG. 14 will be described with reference to the process flow of FIG. 13.

The radio relay device 300 calculates the speed difference 26 Mbps by subtracting the communication speed VRC from the communication speed VBR (S2071). The radio relay device 300 calculates the communication speed per carrier on the basis of the communication speed VRC (S2072). According to FIG. 14, since the present number of carriers is 1 and the communication speed VRC is 24 Mbps, the radio relay device 300 calculates the communication speed per carrier 24 Mbps. Moreover, the radio relay device 300 determines that the absolute value 26 Mbps of the speed difference is equal to or greater than a predetermined value (in this example, the communication speed per carrier 24 Mbps) (S2073: Yes).

Since the communication speed VBR (50 Mbps) is higher than the communication speed VRC (24 Mbps) (S2075: Yes), the radio relay device 300 calculates the number of carriers to be increased on the basis of the speed difference and the communication speed per carrier 24 Mbps (S2056).

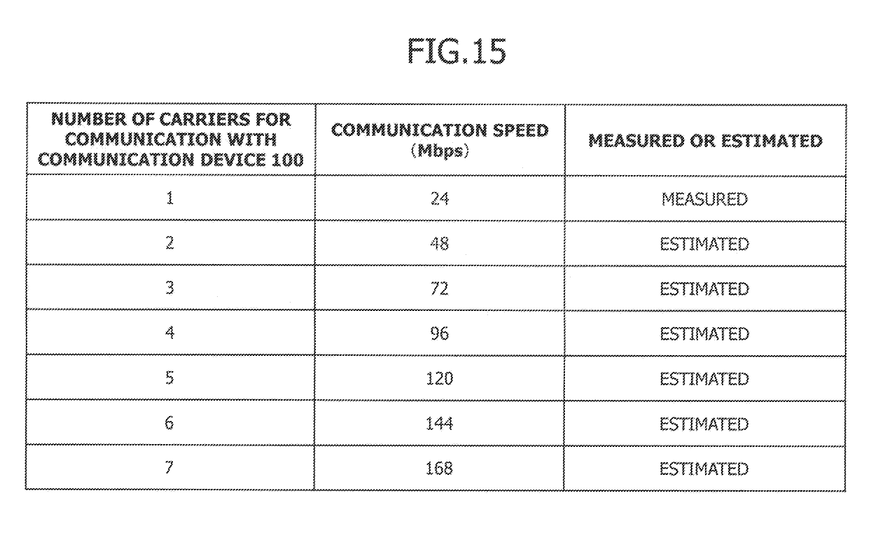

FIG. 15 is a diagram illustrating an example of measured and estimated values of the communication speed for each number of carriers. When communication is performed via Wi-Fi, the number of carriers corresponding to the power of 2 are selected. In FIG. 15, the radio relay device 300 estimates that the communication speed is increased by 72 Mbps from the calculated communication speed per carrier 24 Mbps if four carriers are used by increasing three carriers and that the communication speed is increased by 168 Mbps if eight carriers are used by increasing seven carriers.

The radio relay device 300 determines a minimum number of carriers within a range in which the communication speed VRC is higher than the communication speed VBR when the number of carriers is increased as the number of carriers to be increased. That is, the radio relay device 300 determines a minimum number of carriers exceeding the speed difference as the number of carriers to be increased. As illustrated in FIG. 10, the radio relay device 300 determines the number of carriers to be increased as three carriers (the communication speed is increased by 72 Mbps).

The radio relay device 300 determines the number of carriers 4 obtained by adding the number of carriers to be increased 3 to the present number of carriers 1 as a new number of carriers between the radio relay device 300 and the communication device 100 (S2077).

As described above, the radio relay device 300 increases the number of carriers between the radio relay device 300 and the communication device 100 when the communication speed between the radio relay device 300 and the communication device 100 is lower than the communication speed between the base station device 200 and the radio relay device 300. In this way, it is possible to perform transmission and reception of a maximum amount of data between the radio relay device 300 and the communication device 100 at a high speed in correspondence with the communication speed between the base station device 200 and the radio relay device 300.

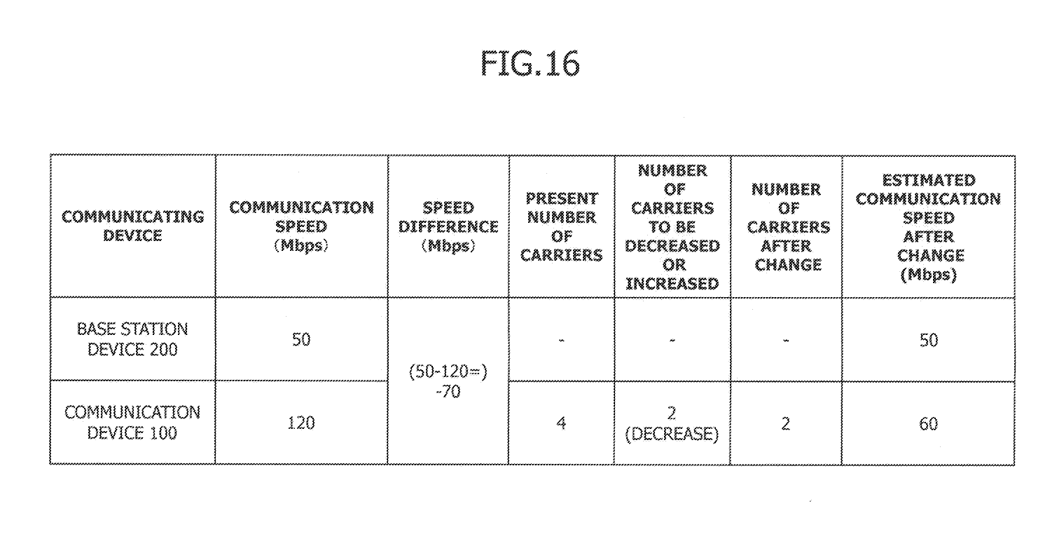

Next, an example in which the number of carriers is decreased will be described. FIG. 16 is a diagram illustrating an example in which the number of carriers is decreased. In FIG. 16, the communication speed (communication speed VBR) with the base station device 200 is 50 Mbps and the communication speed (communication speed VRC) with the communication device 100 is 120 Mbps. Hereinafter, the example of FIG. 16 will be described with reference to the process flow of FIG. 13.

The radio relay device 300 calculates the speed difference −70 Mbps by subtracting the communication speed VRC from the communication speed VBR (S2071). Since the communication speed VRC is 120 Mbps at the present number of carriers 4, the radio relay device 300 calculates the communication speed per carrier 30 Mbps (S2072). Furthermore, the radio relay device 300 determines that the absolute value 70 Mbps of the speed difference is equal to or greater than a predetermined value (in this example, the communication speed per carrier 30 Mbps) (S2073: Yes).

Since the communication speed VBR (50 Mbps) is lower than the communication speed VRC (120 Mbps) (S2075: No), the radio relay device 300 calculates the number of carriers to be decreased on the basis of the speed difference and the communication speed per carrier (S2078).

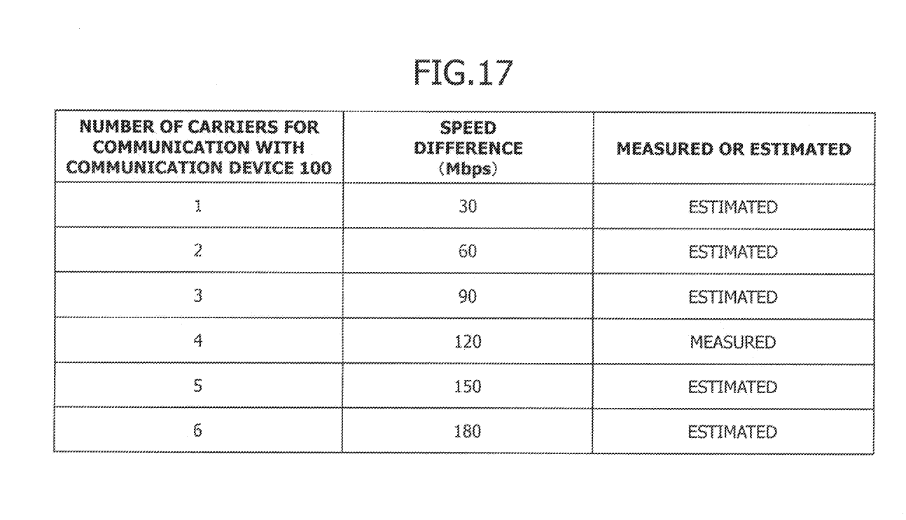

FIG. 17 is a diagram illustrating an example of measured and estimated values of the communication speed for each number of carriers. In FIG. 17, the radio relay device 300 estimates that the communication speed is decreased by 60 Mbps from the calculated communication speed per carrier 30 Mbps if three carriers are used by decreasing two carriers and that the communication speed is decreased by 90 Mbps if one carrier is used by decreasing three carriers.

The radio relay device 300 determines a maximum number of carriers to be creased within a range in which the communication speed VRC is not lower than the communication speed VBR as the number of carriers to be decreased. That is, the radio relay device 300 determines a maximum number of carriers that does not exceed the absolute value of the speed difference as the number of carriers to be decreased. As illustrated in FIG. 17, the radio relay device 300 determines the number of carriers to be decreased as two carriers (the communication speed is decreased by 60 Mbps).

The radio relay device 300 determines the number of carriers 2 obtained by subtracting the number of carriers to be decreased 2 from the present number of carriers 4 as a new number of carriers between the radio relay device 300 and the communication device 100 (S2079).

As described above, the radio relay device 300 decreases the number of carriers when the communication speed between the radio relay device 300 and the communication device 100 is higher than the communication speed between the base station device 200 and the radio relay device 300. In this way, it is possible to release radio resources allocated more than needed for transmitting and receiving data, among the radio resources between the radio relay device 300 and the communication device 100. Moreover, it is possible to reduce power consumption resulting from transmission and reception of carriers by stopping transmission and reception of carriers which do not transmit or receive data.

In the third embodiment, the number of carriers between the radio relay device and the communication device 100 is changed according to the communication speed between the radio relay device 300 and the base station device 200 and the communication speed between the radio relay device 300 and the communication device 100. In this way, it is possible to increase the number of carriers to prevent delay of data received from the base station device 200 when the communication speed with the base station device 200 is higher than the communication speed with the communication device 100, for example. Moreover, it is possible to decrease the number of carriers to prevent resources from being used unnecessarily.

### Fourth Embodiment

Next, a fourth embodiment will be described. The carrier determination process in the third embodiment changes the number of carriers on the basis of the communication speed of a downlink or an uplink. In the fourth embodiment, an index determination process is provided to determine whether the number of carriers is changed on the basis of a downlink communication speed or an uplink communication speed. The radio relay device 300 uses a downlink combination of the downlink communication speeds or an uplink combination of the uplink communication speeds as an index of the carrier determination process.

<Carrier Determination Process>

The sequence of the carrier determination process in the fourth embodiment is the same as the sequence illustrated in FIG. 6. Hereinafter, the communication information acquisition process S204 and the carrier determination process S205 will be described.

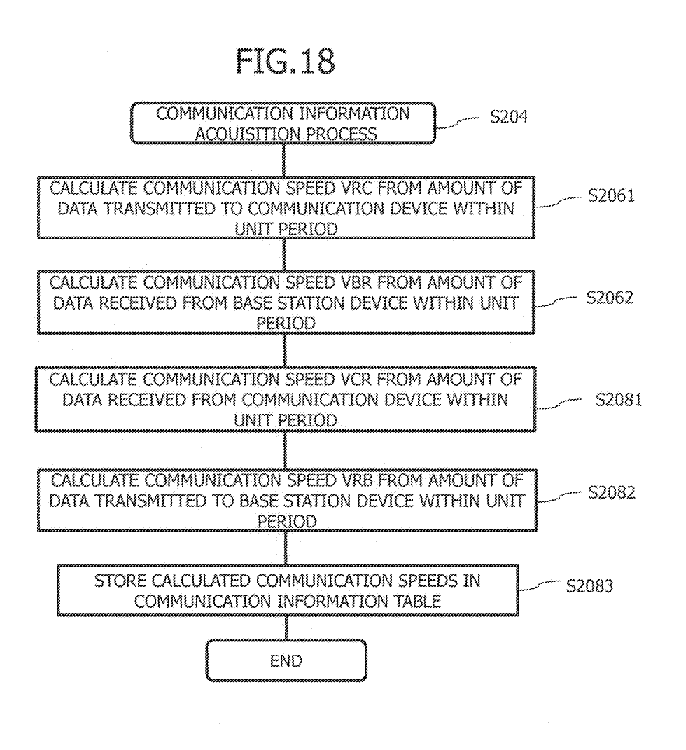

FIG. 18 is a diagram illustrating an example of a process flow of the communication information acquisition process S204 of the fourth embodiment. In addition to the communication information acquisition process of the third embodiment, a communication speed VCR is calculated from the amount of data received from the communication device within a unit period (S2081), and a communication speed VRB is calculated from the amount of data transmitted to the base station device within a unit period (S2082). That is, the radio relay device 300 acquires the communication speeds in both uplink and downlink directions. The radio relay device 300 stores the calculated uplink and downlink communication speeds in the communication information table 323 (S2083).

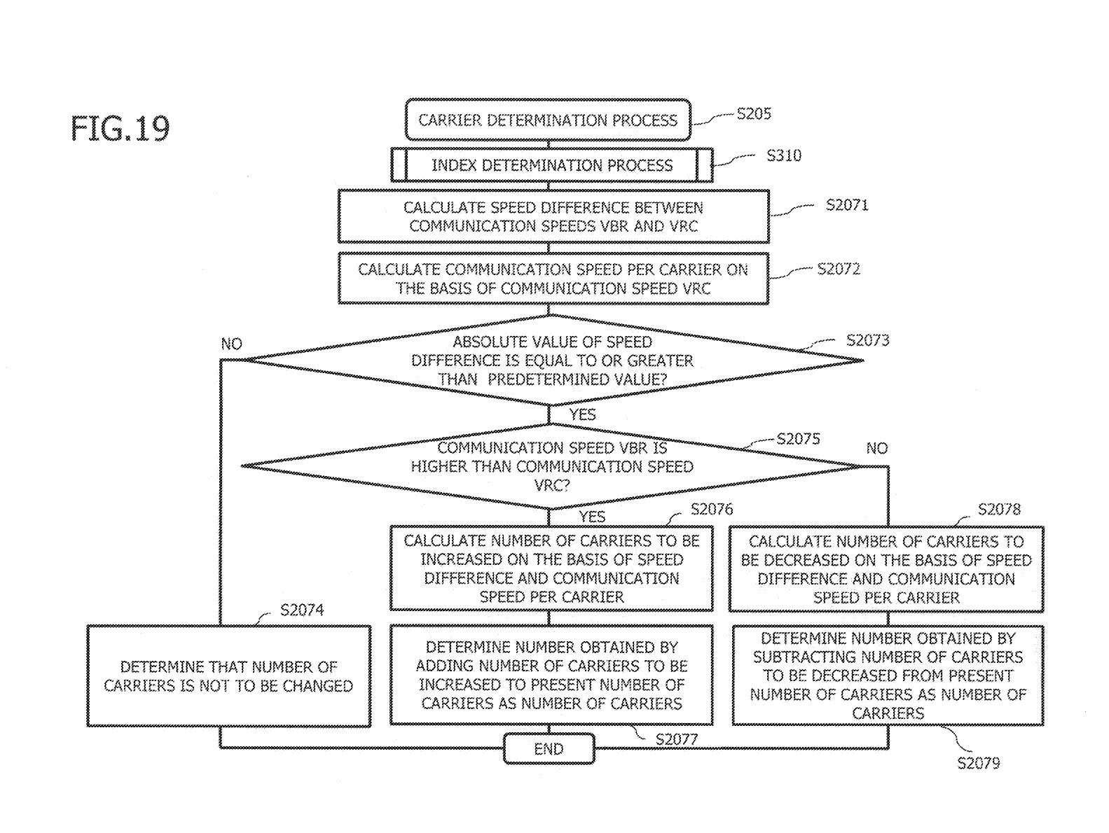

FIG. 19 is a diagram illustrating an example of a process flow of the carrier determination process S205 of the fourth embodiment. The carrier determination process of the fourth embodiment has an index determination process (S310) at the start of the carrier count changing process of the third embodiment. The radio relay device 300 determines whether the number of carriers will be changed on the basis of the downlink communication speed or the uplink developing roller spindle portion at the start of the carrier determination process. Moreover, the radio relay device 300 performs the carrier determination process using the determined downlink or uplink communication speed as an index and determines the number of carriers to be changed.

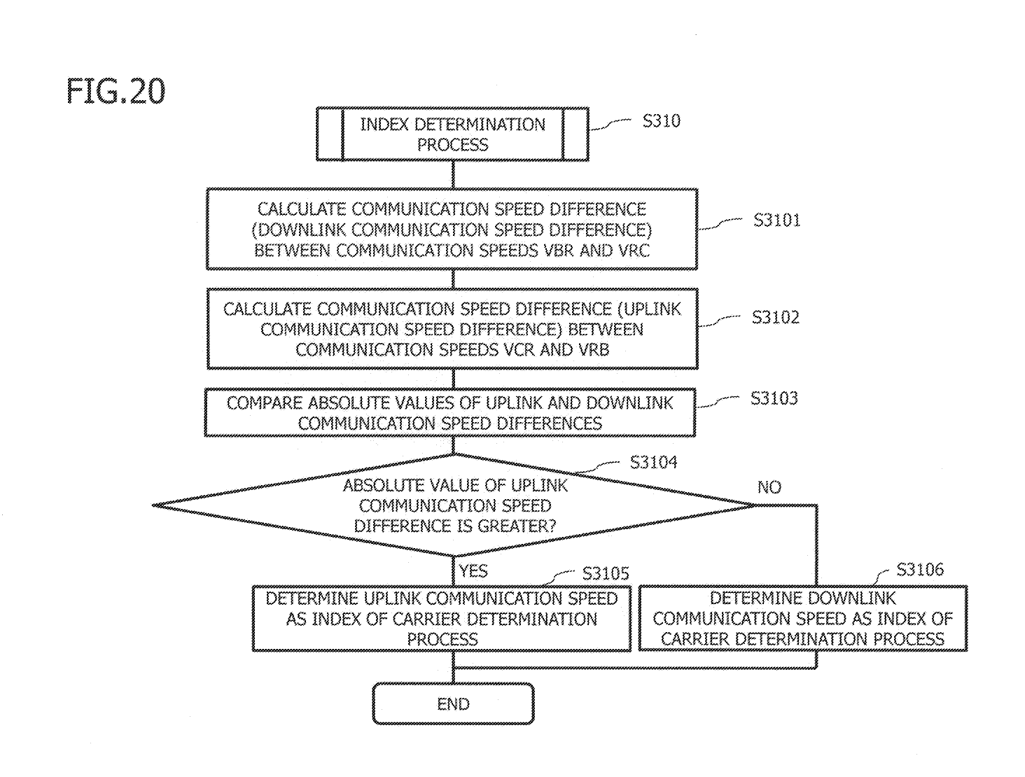

FIG. 20 is a diagram illustrating an example of a process flow of the index determination process. In the index determination process, the radio relay device 300 calculates a communication speed difference (hereinafter referred to as a downlink communication speed difference) between the communication speed VBR and the communication speed VRC (S3101).

Furthermore, the radio relay device 300 calculates a communication speed difference (hereinafter referred to as an uplink communication speed difference) between the uplink communication speed from the radio relay device 300 to the base station device 200 and the uplink communication speed from the communication device 100 to the radio relay device 300 (S3102). Hereinafter, the uplink communication speed from the radio relay device 300 to the base station device 200 will be referred to as a communication speed VRB (Velocity Relay station to Base station), and the uplink communication speed from the communication device 100 to the radio relay device 300 will be referred to as a communication speed VCR (Velocity Communication equipment to Relay station).

The radio relay device 300 compares the absolute values of the uplink and downlink communication speed differences (S3103). When the uplink communication speed difference is greater (S3104: Yes), the radio relay device 300 determines the uplink communication speed (the combination of the communication speed VRB and the communication speed VCR) as the index of the carrier determination process (S3105). Moreover, when the uplink communication speed difference is not greater (S3104: No), the radio relay device 300 determines the downlink communication speed (the combination of the communication speed VBR and the communication speed VRC) as the index of the carrier determination process (S3106).

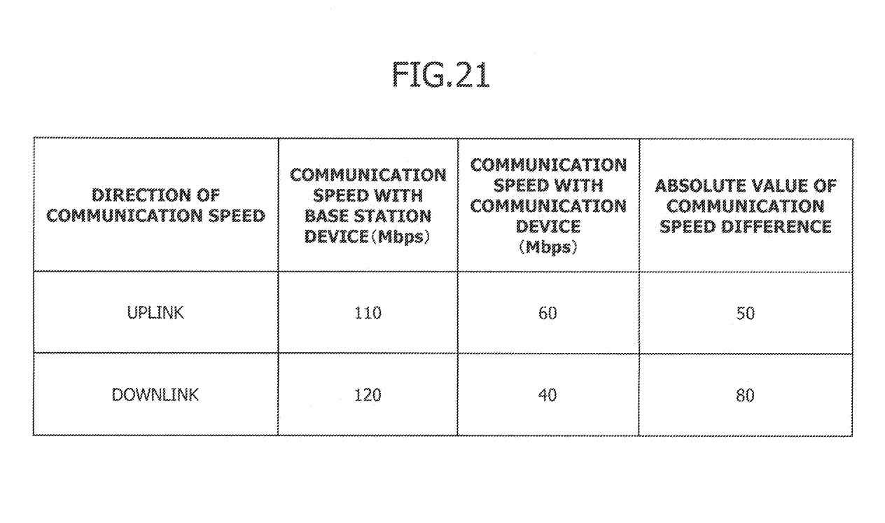

FIG. 21 is a diagram illustrating an example of the uplink and downlink communication speeds. According to FIG. 21, the uplink communication speed with the base station device 200 is 110 Mbps, the uplink communication speed with the communication device 100 is 60 Mbps, and the absolute value of the uplink communication speed difference is 50 Mbps. Moreover, according to FIG. 21, the downlink communication speed with the base station device 200 is 120 Mbps, the downlink communication speed with the communication device 100 is 40 Mbps, and the absolute value of the downlink communication speed difference is 80 Mbps. Hereinafter, the case of FIG. 21 will be described with reference to the process flow of FIG. 20.

The radio relay device 300 compares the uplink and downlink communication speed differences (S3103), determines that the downlink communication speed difference is greater (S3104: No), and determines the downlink communication speed as the index of the carrier determination process (S3106).

A large communication speed difference means that the radio relay device 300 does not use radio resources efficiently. For example, if the communication speed with the communication device 100 is higher than the communication speed with the base station device 200, there are a large number of radio resources to which no data has been transmitted. Moreover, if the communication speed with the communication device 100 is lower than the communication speed with the base station device 200, the amount of data that is not able to be transmitted and received to and from the base station device 200 increases. Therefore, it is naturally preferable to improve the communication speed in the direction in which the communication speed difference is large preferentially.

In the fourth embodiment, the radio relay device 300 determines the greater one of the difference in the communication speed with the communication device 100 and the communication speed with the base station device 200 among the uplink and downlink communication speed differences as an index for determining the number of carriers to be changed. In this way, the radio relay device 300 can improve the communication speed in the direction in which improvement in the radio resources is needed preferentially among the uplink and downlink communication speeds.

In the third and fourth embodiments, the radio relay device 300 may acquire the communication speed between the radio relay device 300 and the communication device 100 from the communication device 100. When the communication speed is acquired from the communication device 100, the radio relay device 300 performs the sequence as illustrated in FIG. 10. In this case, the communication device 100 measures the communication speed and transmits the communication speed to the radio relay device 300 as communication information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio relay device that performs wireless communication with a communication device and a base station device using at least one carrier, the radio relay device comprising:
an acquisition unit that acquires inter-communication-device information on the wireless communication between the radio relay device and the communication device; and
a determination unit that determines the number of carriers between the radio relay device and the communication device on the basis of the inter-communication-device information.

2. The radio relay device according to claim 1, further comprising a control unit that controls the communication device so as to perform communication using the determined number of carriers.

3. The radio relay device according to claim 2, wherein
when performing the control, the control unit transmits a message to the communication device, the message including information that instructs the communication device to change to a communication mode in which communication is performed using the determined number of carriers.

4. The radio relay device according to claim 1, wherein
the inter-communication-device information includes an activation rate indicating a percentage of a period in which data is transmitted and received between the radio relay device and the communication device per unit period, and
the determination unit determines the number of carriers on the basis of the activation rate.

5. The radio relay device according to claim 4, wherein
the determination unit determines, as the number of carriers, the number of carriers corresponding to a maximum activation rate which is equal to or less than 100%, on the basis of the acquired activation rate and the number of carriers between the radio relay device and the communication device when the activation rate is acquired, and,
the activation rate is inverse-proportional to the number of carriers.

6. The radio relay device according to claim 4, wherein
the acquisition unit measures the activation rate to acquire the activation rate.

7. The radio relay device according to claim 4, wherein
the acquisition unit acquires the activation rate by transmitting a request to the communication device to transmit the activation rate measured by the communication device and receiving the activation rate from the communication device as a response to the request.

8. The radio relay device according to claim 1, wherein
the acquisition unit further acquires inter-base-station information on wireless communication between the base station device and the radio relay device, and
the determination unit determines the number of carriers on the basis of the inter-communication-device information and the inter-base-station information.

9. The radio relay device according to claim 8, wherein
the inter-base-station information includes a first communication speed which is a communication speed between the base station device and the radio relay device,
the inter-communication-device information includes a second communication speed which is a communication speed between the radio relay device and the communication device, and
the determination unit increases the number of carriers when the first communication speed is higher than the second communication speed and decreases the number of carriers when the second communication speed is higher than the first communication speed.

10. The radio relay device according to claim 1, wherein
the base station device determines a carrier to be used for wireless communication with the base station device.

11. The radio relay device according to claim 1, wherein
the carrier is a radio resource having a predetermined frequency bandwidth per unit period.

12. The radio relay device according to claim 1, wherein
first communication with the base station device is performed via a public communication network, and second communication with the communication device is performed via a non-public communication network.

13. A communication device that performs wireless communication with a base station device via a radio relay device, the communication device comprising:
a receiving unit that receives a message including information that indicates an instruction to change to a communication mode in which communication is performed using the number of carriers determined by the radio relay device; and
a changing unit that changes to the communication mode in response to the received message.

14. The communication device according to claim 13, further comprising:
a measurement unit that measures an activation rate indicating a percentage of a period in which data is transmitted and received between the radio relay device and the communication device per unit period; and
a transmission unit that transmits the measured activation rate to the radio relay device in response to the request of the radio relay device.

15. A wireless communication method in a radio relay device that performs wireless communication with a communication device and a base station device using at least one carrier, the wireless communication method comprising:
acquiring inter-communication-device information on the wireless communication between the radio relay device and the communication device; and
determining the number of carriers between the radio relay device and the communication device on the basis of the inter-communication-device information.
